(19) United States
(12) Patent Application Publication
(10) Pub. No.: US 2026/0318515 A1
(43) Pub. Date: Oct. 15, 2026

(54) TEMPORARY MAGNETICALLY MOUNTED LIGHTING BRACKET

(71) Applicant: IMT IP Holdings, LLC, Mediapolis, IA (US)

(72) Inventor: Grant Samples, Mediapolis, IA (US)

(21) Appl. No.: 19/643,499

(22) Filed: Apr. 9, 2026

Related U.S. Application Data
(60) Provisional application No. 63/786,892, filed on Apr. 10, 2025.
(60) Provisional application No. 63/974,921, filed on Feb. 3, 2026.

(51) Int. Cl. F21V 21/096; F21S 41/19; F21W 107/10

(52) U.S. Cl. CPC F21V 21/0965; F21S 41/19; F21W 2107/10

(57) ABSTRACT

A temporary light mounting system that is removably attachable to an attachment surface is shown and described. The temporary light mounting system includes a base plate having at least one recess with a magnet disposed in the at least one recess, and a light attachment bracket attached to the base plate. The light attachment bracket is attached to the base plate at an obtuse angle relative to a portion of the base plate lying between he light attachment bracket and a beveled edge of the base plate. Because of the obtuse angle, the base plate may be removably attached at a location on a curved surface (such as a horizontally oriented tank) such that the optical axis of the attached light is parallel to the ground.

### CROSS REFERENCE TO RELATED APPLICATIONS

This application claims the benefit of U.S. Provisional Patent Application No. 63/974,921, filed Feb. 3, 2026 and U.S. Provisional Patent Application No. 63/786,892, filed on Apr. 10, 2025, the entirety of each of which is hereby incorporated by reference.

### FIELD

This disclosure relates to trailer and vehicle lighting systems, and more specifically to a temporary light mounting system designed for attaching third-party lighting units onto steel-surfaced vehicles. The bracket is intended for use on DOT 330 and 331 cargo tank trailers that transport hazardous materials, providing a non-permanent solution for lighting placement without the need for welding or permanent modification.

### BACKGROUND

Certain trailers that transport hazardous materials are specifically designed to transport pressurized hazardous or flammable liquids such as anhydrous ammonia and liquefied petroleum gas (propane) These trailers are constructed of carbon steel cylinder that can hold up to 15,000 gallons of product at one time. Some of these trailers can have working pressures as high as 500 psi. Because of the hazardous and flammable products that are hauled in these trailers they are subject to many regulations and extensive testing to ensure the integrity and the safety of the trailer. This is far stricter and in depth than regular U.S. Department of Transportation (DOT) regulations. Certain of these trailers are subject to rules and regulations that are outlined in the NTTC compliance guidebook title 49 CRF the code of federal regulations (Transportation, Hazardous materials, Cargo tanks)

Many of these trailers that are on the road today are quite old, with some dating back to the early 1960s, because the transportation of hazardous materials technology has not changed for highway transportation. Thus, while the liquid holding tank component of the trailers has not changed much, some accessories and components such as suspensions, wheels, tires, and loading and unloading technologies such as pumps and valves have changed. Many users of these trailers are updating accessories and components rather than buying a completely new trailer due to the high prices.

For safety, regulatory or aesthetic reasons, it is often desirable or necessary to provide auxiliary lighting for hazardous or flammable liquid trailers. Presently, this is done by installing a mounting pad on the trailer which has a welded bracket for attaching a light. Alternatively, new trailers may be ordered with pre-installed mounting pads Or on new equipment it needs to be ordered with mounting pads installed from the manufacturer in the locations that would like to add a permanent light.

Using current technology, if one wants to add a light bracket, a permanent pad varying in size and thickness depending on attachment dimensions is added to the trailer. This pad is required to be added to the trailer body. The bracket itself cannot be directly welded onto the trailer. The pad in summary eliminates a single stress point on the trailer's body. For certain trailers, the required procedure is outlined in 49 CFR Subtitle B, including but not limited to Parts 178, 180, and 393. In addition, the trailer must be taken to an R-stamp certified shop. An R-stamp shop is a facility that holds a National Board ‘R’ Certificate of Authorization, allowing it to perform repairs and alterations on pressure-retaining items such as cargo tanks and adding pads and for example permanent light brackets. Because of the critical nature of these vessels and the risk posed by improper repairs or alterations, only certified shops with qualified personnel are permitted to weld on these tanks. A general-purpose welder or fabrication shop is not authorized to perform this work. A non-certified welder is permitted to weld directly to a pad that had been installed by a R stamp facility.

The required process for welding the pad to the trailer can be involved. The installation costs can be significant as can the downtime while the trailer is out of service for the installation. In one required procedure, the area must first be prepped by grinding or wire wheel to remove all paint and expose bare metal. A steel pad is then welded directly onto the barrel of the trailer under the supervision of an Authorized Inspector (AI). After the weld, the trailer must undergo non-destructive examination (NDE), including wet magnetic particle testing and internal pressure (IP) testing. These tests must be conducted by a registered Cargo Tank (CT) facility in compliance with federal regulations. After passing inspection, the area must be cleaned, masked, and repainted to match the original finish. Only then can third-party lights be mounted.

Most trailer installations are made up of 4 to 12 pads, depending on the lighting configuration desired and trailer size. For installation and associated required testing the price of installation can range from $10,000 to $13,000 depending on the amount of pads installed. This is done in uniform on each side of the trailer. Typical down time is 4 to 8 weeks price does not include the painting of the trailer. Rarely the trailer can be paint matched with that amount of welding and damage done to the original trailer paint. The trailer is then completely sandblasted ($4,000 to $6,000) and then repainted ($5,000 to $15,000)

Thus, a need has arisen for a light mounting system that addresses the foregoing issues.

### SUMMARY

A temporary light mounting system is provided and includes a base plate featuring at least one recess, wherein a respective magnet is positioned within this recess, and a light attachment bracket is attached to the base plate

A temporary light mounting system is provided which comprises a base plate with an upper side and a lower side separated by a base plate thickness, wherein the lower side of this base plate is magnetic, and a light attachment bracket is attached to the upper side of the base plate.

A temporary light mounting system is provided and includes a base plate with an upper and lower side, wherein the lower side comprises a lower surface to which at least one magnet is attached. A light attachment bracket and at least one magnet are attached to the lower side. The at least one magnet is attached to the lower surface of the base plate's lower side such that a respective exposed surface of the at least one magnet protrudes beyond the lower surface of the base plate. Impact tape is applied to the respective exposed surface of the at least one magnets.

### BRIEF DESCRIPTION OF THE DRAWINGS

FIG. 1 is a side elevational view of a cargo tank suitable for use with the temporary light systems of the present disclosure;

FIG. 2 is a close-up side elevational view of a temporary light system of the present disclosure in an installed condition on the cargo tank of FIG. 1;

FIG. 3 is a perspective view of the temporary light system of FIG. 2 in an uninstalled condition;

FIG. 4A is a bottom perspective view of the temporary light mounting system of FIG. 3 used in the temporary light system of FIGS. 2 and 3 with the magnets uninstalled;

FIG. 4B is a bottom perspective view of the temporary light mounting system of FIG. 3 used in the temporary light system of FIGS. 2 and 3 with the magnets installed;

FIG. 5 is bottom perspective, exploded view of the temporary mounting system of FIG. 4B illustrating how the magnets are installed;

FIGS. 6A and 6B are views of the temporary light mounting system of FIG. 3 viewed along the mounting plate width axis with the magnets uninstalled and installed, respectively; and

FIG. 7 is a call out and close-up side elevational view of the temporary light system of FIG. 2 used to illustrate the relationship between the positioning of the temporary light mounting system along a curved surface and the angle defined between the light attachment bracket and the mounting plate of the temporary light mounting system.

### DETAILED DESCRIPTION

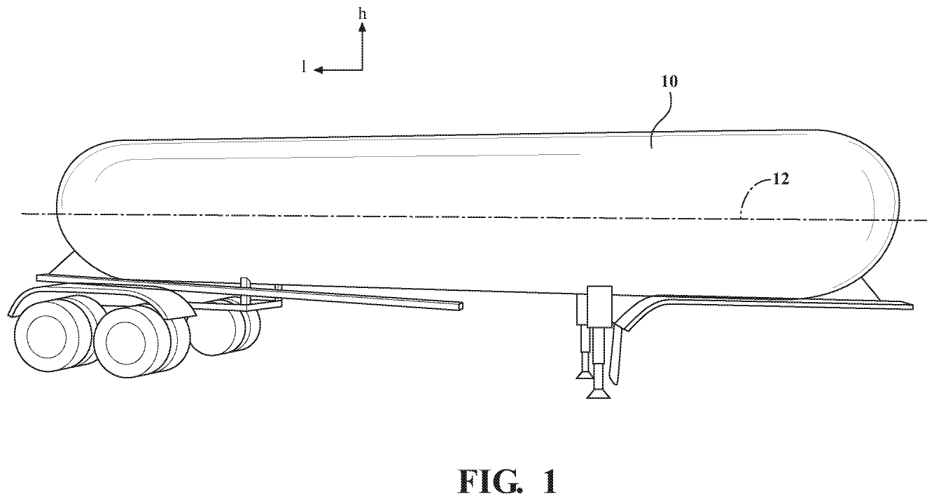

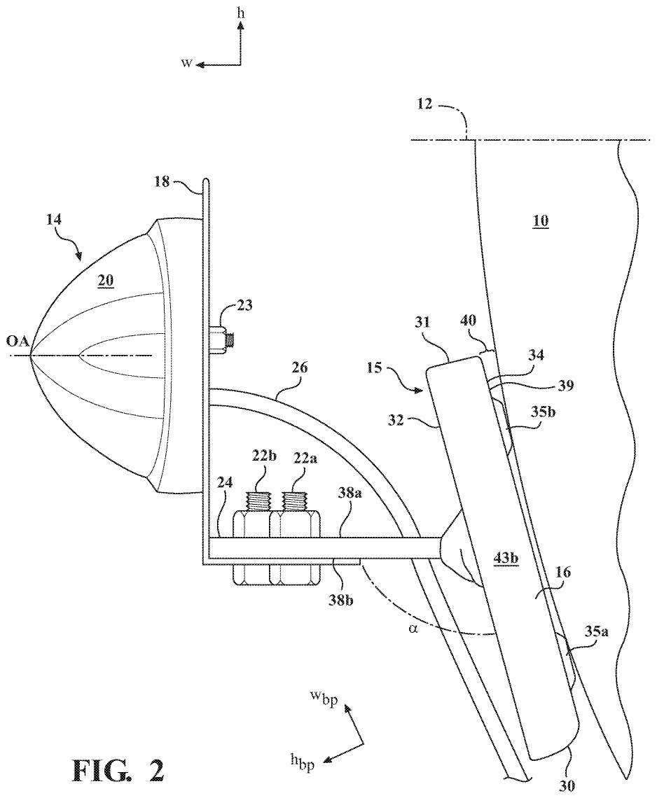

Referring to FIG. 1, cargo tank 10 is generally cylindrical with two opposite, hemispherical ends spaced apart along a length axis l. Tank 10 has a radial axis, and a height axis h that is parallel to the radial axis and perpendicular to the ground. It also has a width axis w along the radial axis and parallel to the ground so that the height and width axes are perpendicular to one another. Tank 10 also has a vertical mid-plane 12 that symmetrically separates the tank 10 into two vertically adjacent semicylindrical sections along length axis l. When tank 10 is viewed perpendicularly to the length and width axes, the vertical mid-plane 12 defines a line that is typically parallel to the ground, as shown in FIG. 2.

As shown in FIG. 2, temporary light system 14 comprises a temporary light mounting system 15, light attachment bracket mounting bracket 18, and light 20. Temporary light mounting system 15 includes a base plate 16 and a light attachment bracket 24. Base plate 16 and light attachment bracket 24 may be constructed from any suitable structural material, including but not limited to metals, metal alloys, polymers, composites, or other rigid materials. Suitable metals and metal alloys include aluminum (e.g., 5052, 5083, 6061, 6063, 7075), mild steel, stainless steel (e.g., 304, 316), carbon steel, titanium, brass, copper, or other ferrous or non-ferrous alloys. In certain examples, base plate 16 may be formed or a magnetic material such that lower side 34 is inherently magnetic.

Suitable non-metallic materials for base plate 16 and light attachment bracket 24 include engineering plastics such as polycarbonate, nylon, acetal, ABS, polypropylene, polyethylene, fiberglass-reinforced plastics (FRP), fiber-reinforced composites (e.g., carbon fiber), or other high-strength synthetic materials. components may be produced by machining, stamping, casting, forging, molding, additive manufacturing (3D printing), or other fabrication processes. Surfaces of base plate 16 and light attachment bracket 24 may be left unfinished or treated with protective coatings, including powder coating, anodizing, painting, electroplating, galvanizing, e-coating, chemical conversion coating, or any other suitable finish.

Base plate 16 is a ridged obround or commonly referred to capsule shape that is the main structural component of temporary light bracket 14. Ends 43a and 43b of base plate 16 are spaced apart from one another along base plate length axis l_{bp} and are semicircular.

Light attachment bracket 24 provides the mounting interface for third party lights while transferring the load of the light and the draft when in transit to the base plate 16. Preferred materials of construction for light attachment bracket 24 include mild steel. In certain examples, light attachment bracket 24 is powder coated at the same time and in the same color as base plate 16. In the same or other examples, light attachment bracket 24 will be powder coated at the same time as the baseplate 16 and will be coated in the same white color or other desired colors.

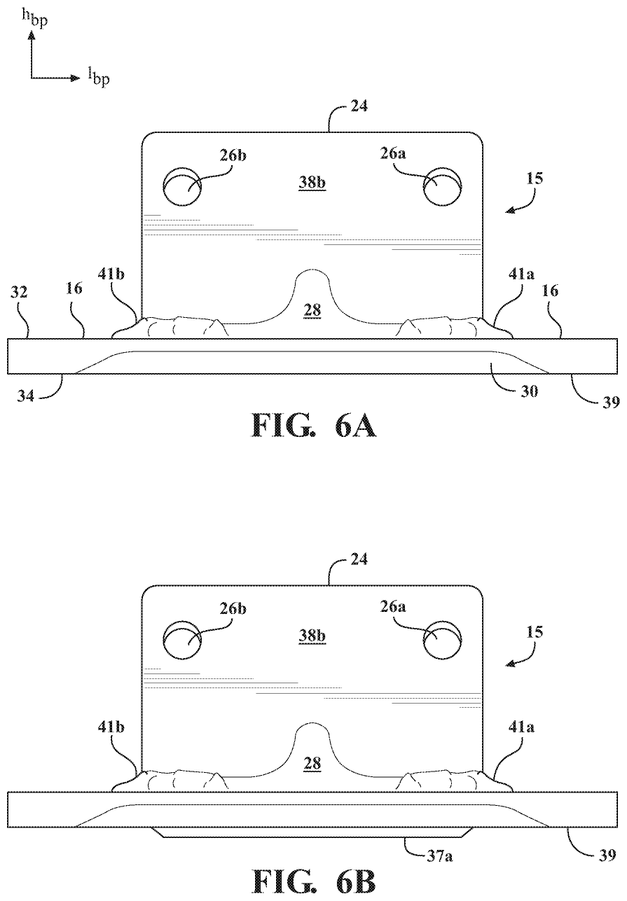

In certain examples, light attachment bracket 24 will be attached to the base plate 16 by using a welding process. This provides a secure attachment and reduces the risk of hardware coming loose over time. In the example of FIGS. 6A and 6B, light attachment bracket 24 is welded at locations 41a and 41b which are spaced apart from one another along the base plate length axis l_{bp} and on each side 38a and 38b of the light attachment bracket 24. As best seen in FIGS. 6A and 6B, in a preferred example, light attachment bracket 24 is flat, plate like structure, which more preferably is a quadrilateral shape and more preferably, rectangular.

Light mounting bracket 18 is attached to a lower surface 38b of light attachment bracket 24. Fasteners 22a and 22b extend through light attachment bracket 24 from upper surface 38a to lower surface 38b of light attachment bracket 24 . . . . Base plate 16 and light attachment bracket 24 may be characterized by a length axis (l_{bp}), a height axis (h_{bp}), and a width axis (w_{bp}). When installed on trailer 10, the temporary light system length axis l_{bp} is parallel to the tank length axis/, the temporary light system width axis w_{bp} is slightly angled relative to trailer height axis h, and the temporary light system height axis (h_{bp}) is slightly angled relative to the tank width axis w.

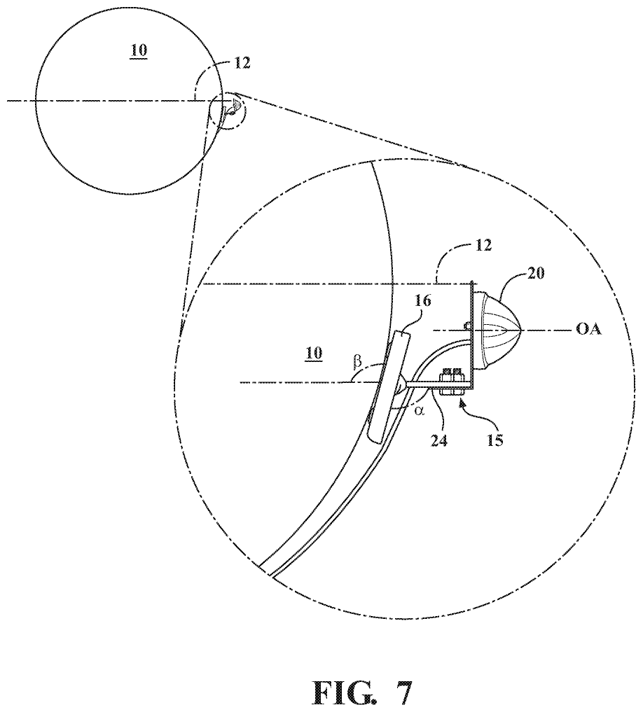

Temporary light system 14 is preferably mounted at a location on an outer surface of cargo tank 10 at a location that is readily visible by other drivers (in the case of a cargo tank). In the example of FIG. 2, the optical axis OA of light 20 (the axis of symmetry for projected light) is preferably parallel to the ground and to vertical mid-plane 12. In many known cargo tanks, the vertical mid-plane 12 is undesirably high off the ground for mounting a light, so it is desirable to mount temporary light system 14 at a location that is vertically beneath the vertical mid-plane 20. However, the lower surface 34 of base plate 16 is generally planar, and therefore, its upper surface 32 tilts downward to face the ground when temporary light system 14 is mounted beneath vertical mid-plane. This tilting can also be seen in FIG. 7.

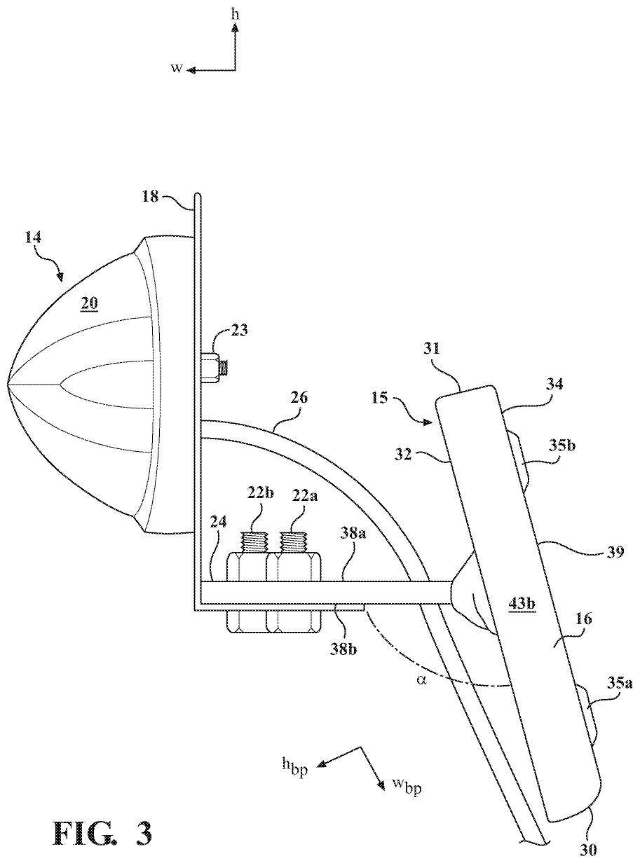

In order to mount light 20 so that its optical axis OA is parallel to the ground, light attachment bracket 24 is attached at a non-orthogonal angle relative to the upper surface 32 of an upper side of base plate 16. As shown in FIGS. 2-3, lower surface 38b of light attachment bracket 24 and upper surface 32 of base plate 16 define two planes that intersect to define an obtuse angle α therebetween. When temporary light mounting system 15 is mounted on tank 10 in an installed configuration, light attachment bracket 24 is preferably parallel to the ground. The obtuse angle α takes into account that base plate 16 is mounted to a curved surface so that the optical axis OA of light 14 may be oriented parallel to the ground. The actual orientation of optical axis OA will depend on the value of the angle α and the location of the base plate 16 on the surface of tank 10 along the height axis h. As indicated in FIG. 7, base plate 16 defines an angle β between lower mounting plate surface 34 and a horizontal plane. When the angle α is equal to the angle β, mounting plate 24 will typically be parallel to the ground.

In certain examples, the obtuse angle α is preferably from greater than 90 degrees to about 135 degrees, more preferably from about 100 degrees to about 125 degrees, and more preferably from about 105 degrees to about 120 degrees. In the example of 331 and 330 cargo tanks, the tanks are typically rounded cylinders that are typically 10 to 45 ft long with individual tanks varying in their dimensions, most notably, the tank diameter, which ranges from about 60 inches to about 90 inches. The obtuse angle α allows the temporary light system 14 bracket 14 to be mounted within the required limits along the tank's height while maintaining the optical axis of light 20 be oriented parallel to the ground.

As mentioned, light attachment bracket 24 is attached to an upper surface 32 of base plate 16 and includes first and second sides 38a and 38b spaced apart along the temporary light system 14 width axis wₘₚ. A patterned wire region is defined on the side of the bracket 24 to which base plate upper surface 32 is attached to define a wire routing gap 28 (FIGS. 6A, 6B) between upper side 32 of base plate 16 and light attachment bracket 24 for receiving power and signal wires 26 that are operatively connected to LEDs contained in lighting module 20 so that the LEDs may be selectively energized and operated. LEDs are merely exemplary and other light sources including incandescent and halogen lights may be used.

Openings 26a and 26b in light attachment bracket 24 are provided so that light attachment bracket mounting bracket 18 may be attached to light attachment bracket 24 via fasteners 22a and 22b (e.g. nuts and bolts). In certain examples, openings 26a, 26b are machined into the light attachment bracket tab 24. In certain examples, openings 26a, 26b are positioned so that commercially available light brackets that are non-removably connected to commercially available lights may be used as light attachment bracket mounting bracket 18 with no modifications needing to be made.

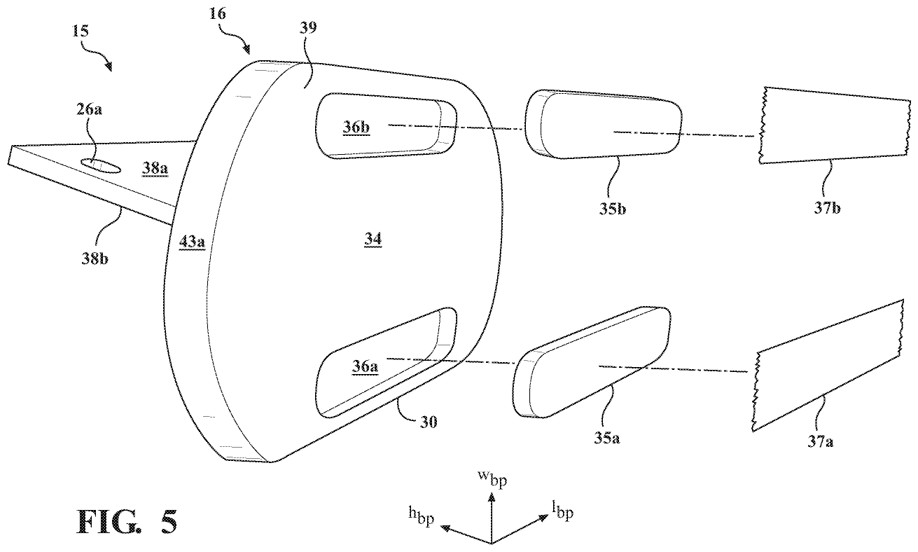

As seen in FIG. 2, temporary light system 14 is preferably removably held to the outer surface of tank 10, and is more preferably held by magnetic attraction. Base plate 16 is preferably magnetic for attachment to ferromagnetic tanks. Referring to FIG. 5, magnet recesses 36a and 36b are formed in bottom side 34 of base plate 16 adjacent bottom surface 39 of bottom side 34. Recesses 36a, 36b are preferably oblong and their lengths are symmetrical about midpoint of base plate 16 along base plate length axis l_{bp}. In preferred examples, the lengths, widths and depths of the recesses 36a and 36b are equal. Recesses 36a and 36b preferably accommodate magnets 35a, 35b, preferably bar magnets, which are substantially rigid and which are fixedly attached within recesses 36a and 36b.

Magnets 35a. 35b are preferably rare earth magnets and preferably have an energy product of at least about 40 MGOe, more preferably at least about 45 MGOe, and still more preferably, at least about 50 MGOe. In certain examples, neodymium-iron-boron (NdFeB) grade 52 magnets (nominal MGOe of 52) are used. Bar magnets are preferred. Preferred magnets also have a dual coating with a nickel base coating topped with an epoxy to reduce corrosion. This dual coating ensures that there will be no accumulation of corrosion and ensures a very long-life span of the magnet. In heavy vibration applications, Neodymium-iron-boron magnets are preferred because they hold firmly in transport environments with road vibration and shock.

The two magnets 35a, 35b will be placed into a respective one of recesses 36a, 36b formed in the underside of base plate 16. In certain examples, an adhesive, preferably an epoxy adhesive, is applied within recesses 36a, 36b and the magnets 35a, 35b are then inserted into the recesses.

In certain applications, minimization of corrosion of the tank 10 metal is critical, which can be problematic due to the trapping of moisture between bottom surface 39 of base plate 16 and tank 10, especially after tank 10 is washed or during periods of high humidity. For example, cargo tank trailers such as 331's are allowed no corrosion past 0.014″ of the designed thickness onto the barrel of the trailer which is a preferred location for mounting temporary light bracket 15. In such cases, air gap 40 beneficially reduces the likelihood of trapping moisture between base plate 16 and tank 10 by allowing air to flow between tank 10 and bottom side 34 of base plate 16. In certain preferred examples, air gap 40 is designed by selecting a degree of protrusion of magnets 35a, 35b beyond base plate lower surface 39. Note that the size of air gap 40 in a direction perpendicular to bottom surface 39 of base plate 16 varies along the tank height h axis because the slope of the outer surface of tank 10 varies along the height axis h. The degree of the protrusion of magnets 35a, 35b beyond base plate lower surface 39 depends on the depth of recesses 36a, 36b and the thickness of magnets 35a, 35b.

In addition, magnets 35a, 35b and the outer surface of tank 10 may be susceptible to corrosion. Suitable tapes for forming tape strips 37a, 37b include those that are adhesive, waterproof, and able to withstand vibration and impact. Impact tape strips 37a, 37b are particularly beneficial during the installation of temporary light mounting system 15 on tank 10 because of the possibility of forceful engagement between magnets 35a, 35b and tank 10, which could result in scratching of the paint on tank 10 or of the magnets 35a, 35b and a resulting increased in the propensity for corrosion. Impact tape strips 37a, 37b are placed over magnets 35a, 35b respectively. Impact tape strips 37a, 37b are primarily used to protect magnets 35a, 35b from corrosion. Especially in environments where winter road salt is used, magnets 35a, 35b may be susceptible to corrosion. In preferred examples, impact tape strips 37a, 37b prevent scratching, distortion, and impact loads, and provide the magnets 35a, 35b, with a sealer and additional surface protection. Exemplary impact tapes suitable for forming impact tape strips 37a, 37b include any durable, flexible material such as a polyurethane, polycarbonate, UHMW-PE, PTFE, other polymer or rubber films.

The impact tape may be applied in configurations other than the impact tape strips 37a, 37b shown in the figures. The impact tape could be applied as multiple sections or one large section on the back side of base plate 16 or on just the exposed surfaces of the magnets. The impact tape may be smooth or textured on side that makes impact with tank 10. The side of the impact tape that is attached to the magnet may be an adhesive backed tape or a non-adhesive tape that is attached using a third-party adhesive to hold the impact tape into place. Suitable tape thicknesses range from about 0.005 inches to 0.060 inches, preferably from about 010 inches to about 0.04 inches, and more preferably form about 0.03 inches to about 0.025 inches.

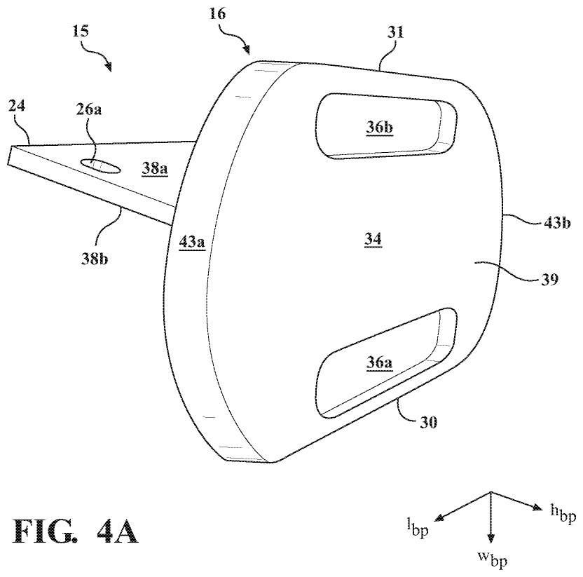

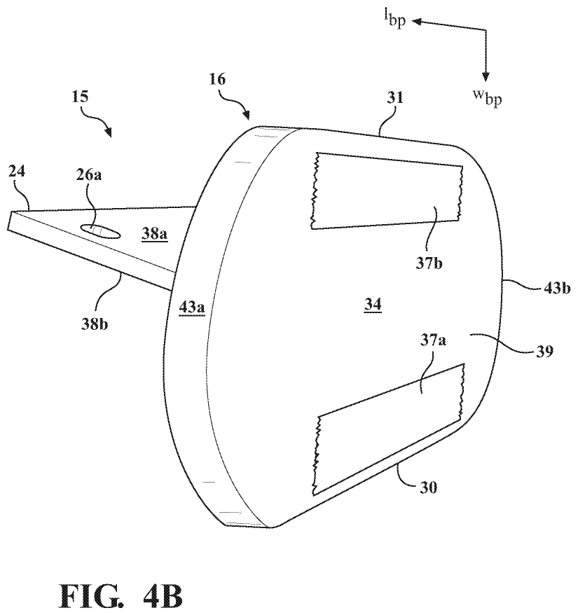

In certain examples, due to the strength of magnets 35a, 35b, engaging the entirety of bottom surface 34 of base plate 16 with tank 10 can cause the bottom surface 34 of base plate 16 to slam into tank 10 which can damage coatings on base plate 16 and tank 10. Rounded or beveled edge 30 allows for a slow and steady placement of the base plate 16. Rounded or beveled edge 30 is best seen in FIGS. 2-3, but the beveling is not visible in FIGS. 4A, 4B or 5 even though it is understood to be present.

Base plate 16 preferably includes a rounded or beveled edge 30 that is spaced apart from a flat edge 31 along the base plate width axis w_{bp}. When installing the temporary light system 14 or temporary light mounting system 14 on tank 10, the user may first engage rounded or beveled edge 30 proximate base plate bottom surface 39 with the tank's surface and then tilt bottom with the tank 10 and then tilt bottom surface 39 toward tank 10 so that the bottom surface 39 is progressively engaged with tank 10 rather than engaged all at once.

### Example 1

A 330 cargo tank is provided and is shaped as a cylinder with rounded hemispherical ends. The tank has a length of between 10 and 45 feet and a diameter of from about 60 inches to about 90 inches. A temporary light system 14 is provided and comprises a base plate 16 and light attachment bracket 24. Base plate 16 has a length of 6.5 in (l_{bp}), width of 3.00 in (w_{bp}), and a thickness of 3/8 in (h_{bp}). The corners of base plate 16 are full semi circles. The obtuse angle α is 105 degrees or 120 degrees. In the former case, the base plate is positioned on tank 10 so that the angle of inclination of base plate 16 (β) is 105 degrees, and in the latter the base plate is positioned on tank 10 so that β is 120 degrees. Each one of two NdFeB grade 52 magnets 35a, 35b is inserted into and affixed within a respective recess 35a and 35b by an epoxy adhesive.

The magnets 35a, 35b have length of 3.97 in, a width of 492 in and a thickness 0.256 in. The edges of each magnet 35a and 34b have light edge chamfering to reduce coating chipping. Each magnet protrudes beyond bottom surface 39 of base plate 16 by 0.0625 inches to 0.0745 inches and has a respective strip 37a, 37b of Yorwe rubber grip impact tape. The thickness is about 0.4 inches. The base plate 16 is attached to tank 10 beneath vertical midplane 12 so that the angle β that defines the extent to which base plate 24 tilts way a from a horizontal plane in a clockwise direction is equal to the angle α that defines the extent to which light attachment bracket 24 tilts away from base plate 16 in a counterclockwise direction. Base plate 16 is preferably attached by engaging beveled edge 30 with tank 10 and rotating base plate 16 in a clockwise direction when viewing the tank 10 along its length axis.

### Example 2

This example illustrates an exemplary method of calculating air gap 40. In this method, the calculated air gap 40 is at the mid-point along the width w_{bp} axis of base plate 40. As best seen in FIG. 2, air gap 40 varies along base plate width axis w_{bp} and has its minimum value at the mid-point of the width axis w_{bp}.

In certain preferred examples, the air gap 40 may be described using equation (1) below, which is a single equation that governs the final mid-span air gap of the magnetic bracket system, incorporating magnet protrusion, tape thickness, coating corrections, and trailer curvature.

(1)G_mid=[(T_m+T_t)−D+T_f−T_b]−[R−{square root over ((R²−(L/2)²))}]

| Symbol | Meaning | Units |
|---|---|---|
| G_mid | Final mid-span air gap | in. |
| T_m | Magnet thickness | in. |
| T_t | Tape thicknessin | in. |
| D | Machined recess depth (before coating) | in. |
| T_f | Coating thickness on floor of magnet recess | in. |
| T_B | Coating thickness on base plate | in. |
| R | Trailer tank radius (½ diameter) | in. |
| L | Spacing of magnet width axis (wbp) mid-point from | |
| | width-wise edges of magnet. | |

In equation (1), the first bracket term defines the design-controlled air gap at the magnets 35a, 35b. The second bracket term subtracts the curvature (sagitta) caused by the round trailer (tank) surface.

### Example 3

In equation (1), the first term may be referred to as the flat surface design air gap term, and the second term may be referred to as the sagittal correction air gap term, the latter of which accounts for the effect of the curvature of the surface to which base plate 16 is applied on the air gap. The following example illustrates the effect of the sagittal term on the airgap for two different flat surface air gaps, 0.0525 inches and 0.0545 inches for a trailer with an 84 inch outer diameter tank.

| Symbol | Meaning | Value Used |
|---|---|---|
| s | Sagitta (extra gap from curvature) | Result |
| R | Trailer radius (½ of diameter) | 42.0 in |
| L | Distance between magnet centers | 1.50 in |
| L/2 | Half magnet spacing | 0.75 in |

### Step-by-Step Example of Sagittal Correction Term Calculation for a (Trailer Diameter=84 in)

R=84÷2=42.0 in
L/2=1.50÷2=0.75 in
R²=42²=1764
(L/2)²=0.75²=0.5625
1764−0.5625=1763.4375
\sqrt{1763.4375}≈41.99330
s=42.0-41.99330=0.00670 in

Sagittal Correction Term Impact on Air Gap for Flat Surface Design Air Gaps of 0.0525 inches and 0.0545 inches.
Flat-surface design air gap: 0.0525″ and 0.0545″

| Flat Gap | Minus Sagitta | Final Mid-Span Gap |
|---|---|---|
| 0.0525″ | −0.00670″ | 0.04580″ |
| 0.0545″ | −0.00670″ | 0.04780″ |

Final Result
Final mid-span air gap: 0.0458″ and 0.0478″
Design Significance

For a given trailer, the variables that can be used to adjust the air gap are the machined (uncoated) recess depth, the thickness of any coating at the bottom of the recess, the thickness of the coating on the bottom surface of the base plate, and the impact tape thickness. As indicated above, for an 84 inch tank outer diameter., the sagittal correction factor is only about 0.0067 inches. Therefore, a temporary light mounting system 15 that provides a desired air gap on one trailer can be expected to provide a substantially similar air gap on trailers of different diameters.

The temporary lighting systems described herein may be used on a variety of different trucks, trailers, and tanks, including DOT 330 & 331 cargo tanks, cargo tank bobtails and delivery trucks, and fuel hauler, as well as utility trucks and agricultural sprayers.

In preferred examples, the temporary lighting systems described herein allow lights to be securely placed on tanks or trailer tanks or other magnetic surfaces without any welding, drilling or other mechanical alteration to the trailer. This also significantly reduces the amount of time vehicle is out of service for light installation as well as the need for permits required for processes that do mechanically alter the trailer. The avoidance of mechanical alteration processes also reduces the overall cost of equipping trailers with lights.

The temporary lighting systems are versatile in their placement and can also be mounted or repositioned in seconds with no tools or special personnel are required to install or reposition the systems. The temporary light systems described herein can also be moved between multiple vehicles. Examples of the temporary light systems described herein also exhibit good weather durability, especially where base plate 16 and light attachment bracket 24 are powder coated and impact tape is used to protect magnet 35a and 35b. The temporary lighting systems described herein also provide a clean finished look and can accommodate accessories other than lights, including sensors, cameras and reflectors.

The foregoing embodiments are exemplary, and many variations may be used without departing from the spirit of this disclosure. Curved ferromagnetic surfaces in need of illumination other than tanks and trailer tanks may benefit from the use of the temporary light system 15. Base plate 14.

What is claimed is:

1. A temporary light mounting system, comprising:
a base plate having at least one recess with a respective magnet disposed in the at least one recess;
a light attachment bracket attached to the base plate.

2. The temporary light mounting system of claim 1, wherein the base plate has an upper side to which the light attachment bracket is attached and a lower side opposite the upper surface and which includes a lower surface, and the at least one recess, and wherein a magnet is disposed in the at least one recess and has an engagement surface that is proud of the lower surface.

3. The temporary light mounting system of claim 2, wherein the lower surface of the base plate is planar.

4. The temporary light mounting system of claim 1, wherein the respective magnet has an energy product of at least 40 MGOe.

5. The temporary light mounting system of claim 1, wherein the base plate is formed of mild steel.

6. The temporary light mounting system of claim 1, wherein the base plate has an upper surface, and the light attachment bracket is oriented at a non-orthogonal angle relative to the upper surface.

7. The temporary light mounting system of claim 1, wherein the light attachment bracket has a wire region that defines a wire routing gap between a side of the light mounting bracket and the base plate.

8. An illuminated cylindrical tank, comprising:
the temporary light mounting system of claim 1, wherein the base plate has a lower surface proximate a surface of the tank and an upper surface facing away from the surface of the tank, and wherein the lower surface of the base plate and the surface of the tank define an airgap between the lower surface of the base plate and the surface of the tank.

9. The illuminated cylindrical tank of claim 8, further comprising:
a light mounting bracket attachment bracket attached to the light attachment bracket, and wherein the light mounting bracket is oriented perpendicularly to the ground.

10. The illuminated cylindrical tank of claim 8, wherein the herein the light attachment bracket is oriented at an obtuse angle relative to the base plate, and the base plate is magnetically attached to the surface of the tank at a location along the tank height axis at which the light attachment bracket is substantially parallel to the ground.

11. A temporary light mounting system, comprising:
a base plate with an upper side and a lower side spaced apart by a base plate thickness, wherein the lower side of the base plate is magnetic; and
a light attachment bracket attached to the upper side of the base plate at a non-orthogonal angle relative to the base plate upper side.

12. The temporary light mounting system of claim 11, wherein the base plate has a beveled edge spaced apart from a flat edge along a width axis of the base plate, the light attachment bracket has a first face that faces the beveled edge and a second face that faces the flat edge, and the first face of the light attachment bracket and a portion of the base plate lying between the first face of the light attachment bracket and the beveled edge of the base plate define an obtuse angle between the first face of the light attachment bracket and the portion of the base plate lying between the first face of the light attachment bracket and the beveled edge of the base plate.

13. The temporary light mounting system of claim 12, wherein the obtuse angle has a value between more than 90 degrees and 135 degrees.

14. An illuminated cylindrical tank, wherein the tank has a vertical mid-plane extending along its length, and the temporary light system of claim 11 is attached to the tank beneath the vertical mid-plane.

15. A temporary light system, comprising:
the temporary light mounting system of claim 11;
a light attachment bracket mounting bracket; and
a light, wherein the light is attached to the light attachment bracket mounting bracket, and the light attachment bracket mounting bracket is attached to the light attachment bracket so that an optical axis of the light is parallel to the light attachment bracket.

16. An illuminated tank, comprising:
a tank having a vertical mid-plane spaced above the ground;
the temporary light mounting system of claim 11; and
a light attached to the temporary light mounting system, wherein the temporary light mounting system is magnetically attached to the tank between the vertical mid-plane and the ground to define an air gap between the lower side of the base plate and the tank.

17. The temporary light system of claim 11 wherein the lower side of the base plate comprises a lower surface and at least one recess, the temporary light system further comprising at least one magnet, each of the at least one magnet being disposed in a respective one of the at least one recess so that a respective exposed surface of each at least one magnet is proud of the lower surface of the base plate.

18. The temporary light system of claim 11, further comprising respective strips of impact tape applied over each at least one magnet.

19. A temporary light mounting system comprising:
a base plate having an upper and a lower side, the lower side comprising a lower surface;
a light attachment bracket;
at least one magnet attached to the lower side of the base plate such that a respective exposed surface of the at least one magnet is proud of the lower surface; and
impact tape applied to the respective exposed surface of the at least one magnet.

20. The temporary light mounting system of claim 19, wherein the lower side of the base plate has at least one recess in which the at least one magnet is disposed such that the respective exposed surface of the at least one magnet is proud of the lower surface.
